(19) United States
(12) Patent Application Publication
(10) Pub. No.: US 2006/0091157 A1
(43) Pub. Date: May 4, 2006

(54) High-barrier coextruded tubular containers

(76) Inventor: Srinivas Nomula, Hartsville, SC (US)

Correspondence Address: ALSTON & BIRD LLP;BANK OF AMERICA PLAZA, 101 SOUTH TRYON STREET, SUITE 4000, CHARLOTTE, NC, 28280-4000, US

(21) Appl. No.: 10/979,911

(22) Filed: Nov. 2, 2004

(51) Int. Cl. B65D 88/54; G01F 11/06; G01F 11/30; G01F 11/36; G01F 11/42

(52) U.S. Cl. 222/326

(57) ABSTRACT

A caulk tube is coextruded as a multi-layer laminate. In one embodiment of the invention, the inner layer of the tube is formed of polyacrylonitrile-based resin for good chemical/solvent resistance, and an outer layer is formed of polyethylene. A middle tie layer bonds the polyacrylonitrile-based and polyethylene layers together. The tie layer in some embodiments comprises a composition based on linear low-density polyethylene (LLDPE); for example, an anhydride-modified LLDPE resin is a particularly preferred tie layer composition. Alternatively, the tie layer composition can be based on ethylene vinyl acetate (EVA). In another embodiment of the invention, the inner layer of the tube comprises polyethylene and the outer layer comprises polyacrylonitrile.

### BACKGROUND OF THE INVENTION

This invention relates in general to coextruded tubular containers, and more particularly relates to high-barrier coextruded containers such as caulk tubes.

Caulks often contain chemicals and solvents that can attack the material of which the caulk cartridge is made. Plastic caulk cartridges generally are formed by extruding a tube and then attaching an injection-molded nozzle or tip to one end of the tube; alternatively, it is possible to injection-mold the tube and tip in one piece. One known plastic cartridge is extruded from a polyacrylonitrile-based resin (specifically, Barex®), which has good resistance to chemicals/solvents in caulking compounds. However, this resin is expensive. Other caulk cartridges are extruded from high-density polyethylene (HDPE), which is a good moisture barrier but does not have good chemical/solvent resistance.

### BRIEF SUMMARY OF THE INVENTION

In accordance with the invention, a caulk tube is coextruded as a multi-layer laminate. In one embodiment of the invention, the inner layer of the tube is formed of a polyacrylonitrile-based resin (such as Barex®) for good chemical/solvent resistance, and an outer layer is formed of a polyethylene, preferably HDPE or a blend of HDPE with other constituents such as medium-density polyethylene (MDPE), low-density polyethylene (LDPE), or the like. A middle tie layer bonds the polyacrylonitrile-based and polyethylene layers together. The tie layer in some embodiments comprises a composition based on linear low-density polyethylene (LLDPE); for example, an anhydride-modified LLDPE resin is a particularly preferred tie layer composition.

Alternatively, the tie layer composition can be based on ethylene vinyl acetate (EVA).

In another embodiment of the invention, the inner layer of the tube comprises polyethylene and the outer layer comprises polyacrylonitrile-based resin.

The polyethylene layer can provide structural strength and rigidity as well as moisture resistance. The polyacrylonitrile-based layer can be relatively thin, such as about 0.001 to 0.005 inch (0.025 to 0.127 mm). In comparison, the total wall thickness of the caulk tube can be about 0.030 to 0.050 inch (0.76 to 1.27 mm). Thus, in accordance with the invention, the use of relatively expensive polyacrylonitrile-based resin can be reduced considerably relative to the all-polyacrylonitrile-based caulk tubes of the prior art, while substantially preserving the chemical/solvent resistance provided by this material.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a schematic depiction of an apparatus and process for making a high-barrier coextruded caulk tube in accordance with an embodiment of the invention;

FIG. 2 is a perspective view of a caulk cartridge in accordance with one embodiment of the invention;

FIG. 3 is a cross-sectional view through the wall of a caulk tube in accordance with one embodiment of the invention;

FIG. 4 is a cross-sectional view through the wall of a caulk tube in accordance with another embodiment of the invention;

FIG. 5 is a cross-sectional view through the nozzle region of a caulk tube in accordance with one embodiment of the invention; and

FIG. 6 is a view similar to FIG. 5, showing a further embodiment of the invention.

### DETAILED DESCRIPTION OF THE INVENTION

The present inventions now will be described more fully hereinafter with reference to the accompanying drawings, in which some but not all embodiments of the invention are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

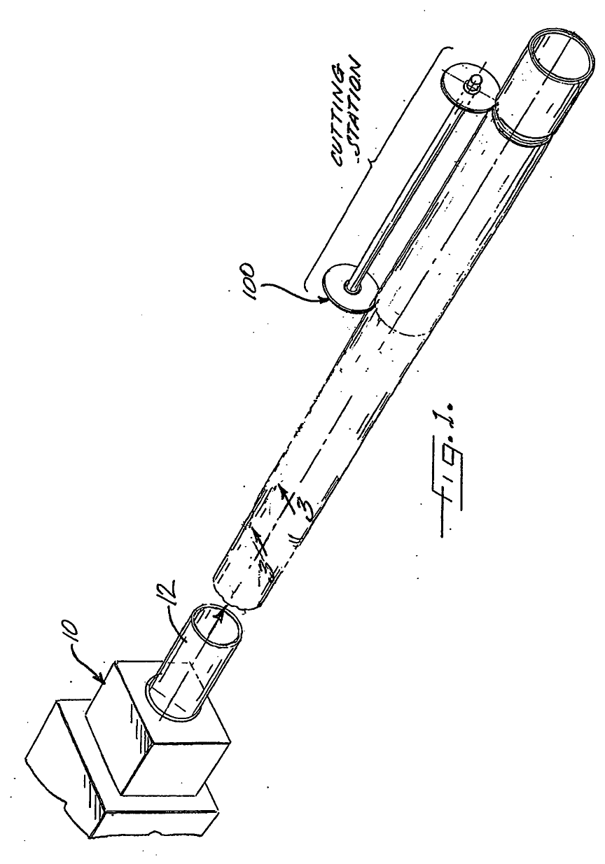

A process and an apparatus for making a caulk tube in accordance with the invention are depicted in FIG. 1. An extruder 10 is provided for coextruding a tube 12 from molten and flowable polymer materials, specifically, a first material comprising polyacrylonitrile-based resin, a second material comprising polyethylene resin, and a tie material for joining together layers of the first and second materials. The tie material can comprise anhydride-modified linear low-density polyethylene (LLDPE); alternatively, the tie material can comprise ethylene vinyl acetate (EVA). As known in the art, the extruder 10 has a die (not shown) configured with three concentric annular die slots that are respectively fed with the three different polymer materials in molten and flowable form, and as a result a multi-layer tube 12 is extruded from the extruder die. The extruder generally also includes a cooling chamber (not shown) for partially cooling the tube before it exits the extruder. At a downstream cutting station, a cutting device 100 cuts the tube 12 into lengths suitable for incorporation into containers such as caulk cartridges, as further described below.

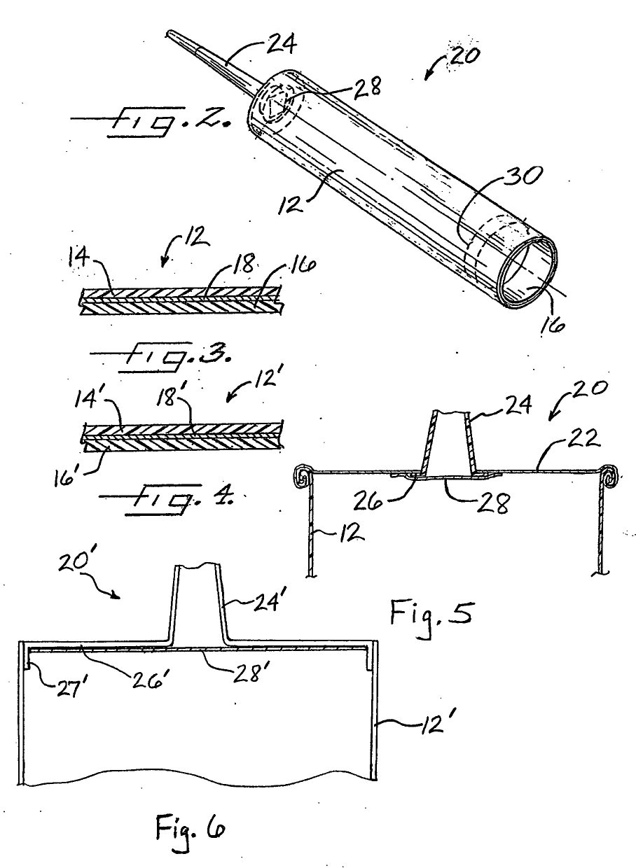

With reference to FIG. 3, the structure of a first embodiment of the tube 12 is shown. The tube 12, as noted, comprises three layers: an outer layer 14 forming the outer surface of the tube, an inner layer 16 forming the inner surface of the tube, and a tie layer 18 sandwiched between the inner and outer layers for anchoring these layers to each other. In this embodiment, the outer layer 14 comprises polyethylene (preferably HDPE, or a blend of HDPE with one or more other ingredients such as MDPE and/or LDPE), while the inner layer 16 comprises a polyacrylonitrile-based resin. The tie layer 18, as noted, can comprise anhydride-modified LLDPE or EVA. For ease and clarity of illustration, in FIG. 3 as well as FIG. 4, the inner and outer layers are not shown to scale. In reality, the polyacrylonitrile-based layer 16 can be substantially thinner than the polyethylene layer 14. As an illustrative example, the total wall thickness of the tube 12 can range from about 0.030 inch (0.76 mm) to about 0.050 inch (1.27 mm), and more preferably about 0.035 to 0.040 inch (0.89 to 1.02 mm). Of that total thickness, the polyacrylonitrile-based layer 16 can comprise about 0.001 to 0.005 inch (0.025 to 0.127 mm). Thus, the polyacrylonitrile-based layer can comprise a very small percentage of the overall wall thickness, such as less than about 20 percent, more preferably about 2-15 percent.

FIG. 4 depicts an alternative caulk tube 12′ having an outer layer 14′ of polyacrylonitrile-based resin, an inner layer 16′ of polyethylene, and a tie layer 18′ comprising either of the tie materials previously noted.

The polyacrylonitrile-based layer 16, 14′ in the caulk tubes provides resistance against the escape of solvents or chemicals contained in the caulking composition. The polyethylene material that makes up the substantial majority the tube wall is a poor barrier against the passage of many solvents commonly contained in caulking compositions, although it is a good barrier against moisture. Polyacrylonitrile-based resin, however, is an excellent barrier against such solvents and other chemicals, but, as noted, is relatively expensive. The caulk tubes of the invention combine the structural strength and rigidity and the moisture barrier performance of polyethylene, as well as the chemical/solvent resistance of polyacrylonitrile-based resin, in a cost-effective and advantageous manner.

A caulk cartridge 20 in accordance with one embodiment of the invention is shown in FIG. 2, and a cross-sectional view through the cartridge is shown in FIG. 5. The cartridge 20 includes a tube 12 of the construction described in connection with FIG. 3. At one end of the tube 12, a metal end 22 is attached to the tube by double-seaming or the like. The metal end 22 includes an aperture through which a plastic nozzle 24 (which can be injection-molded of HDPE, for example) is inserted. The nozzle generally tapers from its base to its tip, and the base defines a small flange 26 that abuts the inner surface of the metal end 22 to substantially seal the interface between the nozzle and metal end. To ensure a substantially hermetic interface prior to the caulk cartridge being used for the first time, a barrier patch 28 is sealed to the inner surface of the metal end, covering the base end of the nozzle, as shown in FIG. 5. The barrier patch 28 generally comprises a metal foil layer and a sealant layer for sealing the patch to the metal end. Once the nozzle end of the cartridge is assembled, the tube 12 is filled with caulking compound and a sliding plunger 30 is inserted into the opposite end of the tube 12 to substantially seal the cartridge. The plunger can comprise metal or other suitably stiff material that is also a good barrier to the solvents and chemicals in the caulking compound. The plunger fits closely in the tube 12 so as to substantially seal against the inner surface of the tube, but the plunger is axially slidable to force caulking compound out the nozzle 24 when advanced by a piston rod of a caulking gun or the like.

An alternative embodiment of a caulking cartridge 20′ in accordance with the invention is shown in FIG. 6. This cartridge employs a tube 12′ having a construction such as in FIG. 4, wherein the inner surface of the tube is defined by the polyethylene layer 16′. Because of this arrangement of the layers of the tube, the metal end type construction of FIG. 5 need not (although it can) be used with this tube. Instead, the cartridge 20′ includes a nozzle 24′ of polyethylene or other material that is spin-weldable to the polyethylene inner layer of the tube 12′. The nozzle 24′ has a large base flange 26′ whose outer diameter is substantially equal to the inner diameter of the tube, and optionally can include a skirt 27′ to provide a greater axial extent at the interface with the caulk tube. The nozzle is spin-welded to the caulk tube to attach the nozzle in sealed fashion. Because polyethylene typically does not provide barrier performance against solvents and chemicals that may be contained in the caulking compounds, a barrier patch 28′ that covers substantially all surfaces of the polyethylene nozzle exposed to the caulking compounds is required. The barrier patch can comprise a metal foil layer and a sealant layer for sealing to the nozzle flange 26′.

Alternatively, the nozzle 24′ can comprise polyethylene that has been fluorinated to improve its barrier performance, such that the large barrier patch 28′ is not required (i.e., a small patch can be used, such as the patch 28 shown in FIG. 1).

Still another embodiment of the invention comprises a caulk tube having a tubular body constructed as shown in FIG. 4, having the polyacrylonitrile-based resin layer on the inside and the polyethylene layer on the outside. However, instead of seaming a metal end onto the body, a nozzle that is injection-molded of polyacrylonitrile-based resin is spin-welded to the tubular body, similar to the embodiment of FIG. 6. Since the polyacrylonitrile-based resin has good barrier properties, the large patch 28′ is not required (i.e., a small patch can be used, such as the patch 28 shown in FIG. 1).

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A container for a product, comprising:
a coextruded tubular body, the body comprising an inner layer and an outer layer and a tie layer disposed therebetween, opposite sides of the tie layer being respectively joined to the inner layer and the outer layer, one of the inner and outer layers comprising polyacrylonitrile-based resin and the other of the inner and outer layers comprising polyethylene, and the tie layer comprising a composition based on linear low-density polyethylene.

2. The container of claim 1, wherein the tie layer comprises anhydride-modified linear low-density polyethylene.

3. The container of claim 1, wherein the inner layer comprises polyethylene, and further comprising a closure having a radially outer surface formed of polyethylene and welded to the inner layer of the body.

4. The container of claim 3, wherein the closure comprises a molded plastic nozzle for dispensing product from the container.

5. The container of claim 4, wherein the nozzle comprises fluorinated high-density polyethylene.

6. The container of claim 1, wherein the inner layer comprises polyacrylonitrile-based resin, and further comprising a closure attached to the body at one end thereof, the closure comprising a metal end seamed onto the body, and a plastic nozzle joined to the metal end.

7. The container of claim 1, wherein the tubular body has a wall thickness of about 0.030 inch to about 0.050 inch.

8. The container of claim 7, wherein the polyacrylonitrile-based layer comprises less than 20 percent of the wall thickness.

9. The container of claim 7, wherein the polyacrylonitrile-based layer comprises about 2 to 15 percent of the wall thickness.

10. The container of claim 1, wherein the inner layer comprises polyacrylonitrile-based resin, and further comprising a nozzle formed of polyacrylonitrile-based resin and spin-welded to the inner layer of the tubular body.

11. A container for a product, comprising:
a coextruded tubular body, the body comprising an inner layer and an outer layer and a tie layer disposed therebetween, opposite sides of the tie layer being respectively joined to the inner layer and the outer layer, one of the inner and outer layers comprising polyacrylonitrile-based resin and the other of the inner and outer layers comprising polyethylene, and the tie layer comprising a composition based on ethylene vinyl acetate.

12. The container of claim 11, wherein the inner layer comprises polyethylene, and further comprising a closure having a radially outer surface formed of polyethylene and welded to the inner layer of the body.

13. The container of claim 12, wherein the closure comprises a molded plastic nozzle for dispensing product from the container.

14. The container of claim 13, wherein the nozzle comprises fluorinated high-density polyethylene.

15. The container of claim 11, wherein the inner layer comprises polyacrylonitrile-based resin, and further comprising a closure attached to the body at one end thereof, the closure comprising a metal end seamed onto the body, and a plastic nozzle joined to the metal end.

16. The container of claim 11, wherein the inner layer comprises polyacrylonitrile-based resin, and further comprising a nozzle formed of polyacrylonitrile-based resin and spin-welded to the inner layer of the tubular body.

17. A caulk tube, comprising:
a coextruded tubular body comprising an inner layer and an outer layer and a tie layer disposed therebetween, opposite sides of the tie layer being respectively joined to the inner layer and the outer layer, one of the inner and outer layers comprising polyacrylonitrile-based resin and the other of the inner and outer layers comprising high-density polyethylene, and the tie layer comprising one of anhydride-modified linear low-density polyethylene and ethylene vinyl acetate;
a plunger disposed within the body and axially slidable therein for advancing caulk contained in the body toward one end thereof; and
a dispensing nozzle joined to the one end of the body.

18. The caulk tube of claim 17, wherein the inner layer of the body comprises high-density polyethylene forming an inner surface of the body, the nozzle is injection-molded from high-density polyethylene, and the nozzle is spin-welded to the inner surface of the body.

19. The caulk tube of claim 18, wherein the nozzle comprises fluorinated high-density polyethylene.

20. The caulk tube of claim 18, further comprising a barrier patch attached to an inner surface of the nozzle, the patch structured and arranged to substantially prevent contact between caulk and the nozzle until the patch is pierced to allow dispensing of caulk through the nozzle.

21. The caulk tube of claim 17, wherein the inner layer comprises polyacrylonitrile-based resin, and the nozzle comprises polyacrylonitrile-based resin, the nozzle being spin-welded to the inner surface of the body.
